(19) United States
(12) Patent Application Publication
(10) Pub. No.: US 2009/0077583 A1
(43) Pub. Date: Mar. 19, 2009

(54) System, Apparatus, and Method for a Remote Commander for Internet Protocol Television

(75) Inventors: Nobukazu Sugiyama, San Diego, CA (US); Ryuichi Iwamura, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: SONY CORPORATION, Tokyo (JP); SONY ELECTRONICS, INC., Park Ridge, NJ (US)

(21) Appl. No.: 11/856,580

(22) Filed: Sep. 17, 2007

(51) Int. Cl. H04N 5/445

(52) U.S. Cl. 725/39

(57) ABSTRACT

The present invention pertains to a method and apparatus for displaying electronic programming guide (EPG) data, received from an Internet Protocol Television (IPTV), on a remote commander. In one embodiment, the method may include receiving electronic programming guide (EPG), that includes a plurality of unique identification numbers and corresponding program titles, data at a remote commander. The method may also include storing the EPG data in a memory of the remote commander In one embodiment, the method may also include displaying the plurality of program titles on a display of the remote commander, and transmitting the unique identification number corresponding to the selected title to an IPTV in response to receiving a selection of a title at the remote commander.

### FIELD OF THE INVENTION

The present invention relates to the field of internet protocol television; more particularly, the present invention relates to a remote commander for displaying electronic programming guide data for an internet protocol television.

### BACKGROUND OF THE INVENTION

Internet protocol television (IPTV) is drawing much attention as the internet continues to expand and deliver new forms of media. Whereas cable television providers provide end users with electronic programming guides (EPGs) that provide an on-screen television listing of programming and content that a subscriber or digital television viewer has available to them, conventional IPTV systems do not provide viewers with EPGs. Rather, IPTV servers provide end users with universal resource locators (URLs) for specific programming content. The URLs, however, provide minimal information to a user and fail to provide a convenient listing of programming, content, etc. regarding available programming.

A further complication arises when a remote commander, or remote control, is included in an IPTV system. When an IPTV system obtains a list of URLs, a user may scroll through the list on an IPTV client display with the remote commander. After a particular URL is chosen, content pointed to by the URL is acquired and displayed to the end user. However, the user is merely provided with the ability to scroll and navigate through titles via the remote on a television screen. The user is still not provided with sufficient programming information regarding available programming and content.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a network architecture in which embodiments of the present invention may operate.

FIG. 2 illustrates one embodiment of an architecture of a remote commander and an internet protocol television and internet protocol television client.

FIG. 3 is a flow diagram of one embodiment of an internet protocol television system obtaining programming data.

FIG. 4 is a flow diagram of one embodiment of an internet protocol television system obtaining content selected by a user.

FIG. 5 is a flow diagram of one embodiment of a remote commander utilizing programming data.

FIG. 6 illustrates one embodiment of an electronic programming guide data transfer stream.

FIG. 7 is a flow diagram of one embodiment for classifying electronic program guide data at an internet protocol television.

FIG. 8 is a flow diagram of one embodiment for transferring the classified program data to a remote commander.

FIG. 9 illustrates one embodiment of a prioritized program content data stream.

### DETAILED DESCRIPTION OF THE PRESENT INVENTION

A method, apparatus, and system for a remote commander for internet protocol television (IPTV) is described. In one embodiment, a remote commander receives electronic programming guide (EPG) data for use with an IPTV. The EPG data, which provides for a listing of available channels program content data, related content data, etc. is stored in a memory of the remote commander. In one embodiment, a communications link is activated in order for the remote commander to receive EPG data.

The remote commander may then display at least a plurality of program titles of a display of the remote commander. In one embodiment, in response to a user's receipt of a user's selection of a title at the remote commander, the unique identifier corresponding to the selected title is transmitted to an IPTV.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer systems registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

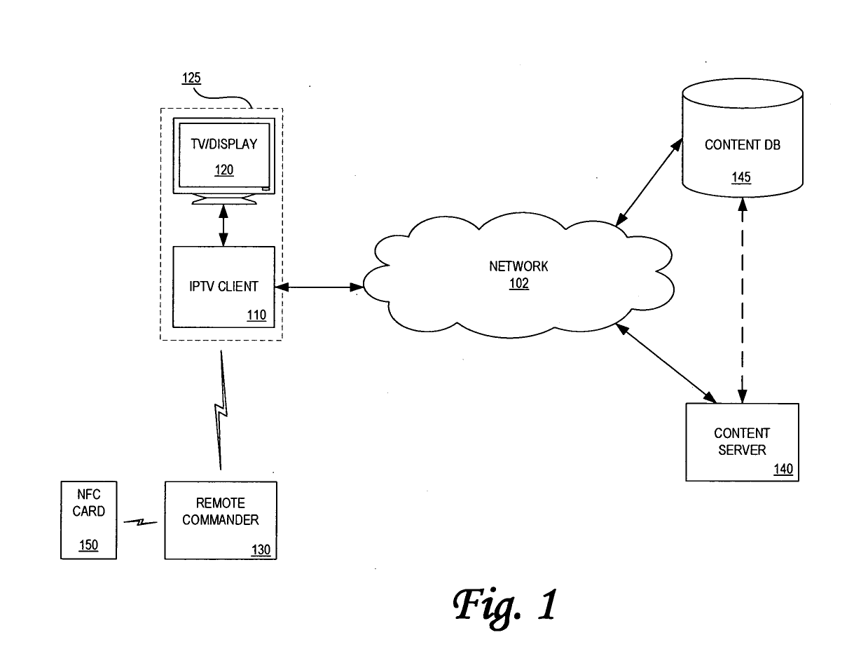

FIG. 1 illustrates one embodiment of a network architecture in which embodiments of the present invention may operate. The architecture includes a remote commander 130, such as a portable and/or handheld remote control, for selecting internet protocol television content (IPTV) to be displayed on TV/display 120 by IPTV client 110. Although IPTV client 110 may be a set-top-box, dedicated IPTV client, personal computer system, etc., IPTV client 110 may also be integrated with TV 120 as a single unit. To avoid obscuring the present invention, the remaining discussion will refer to an integrated TV 120 and IPTV client 110 system as an internet protocol television 125. However, the techniques described herein may be implemented by a remote commander and any of a set-top-box, dedicated IPTV client, personal computer system, etc.

As will be described in greater detail below, in embodiment, remote commander 130 communicates with near filed communication (NFC) card 150 and IPTV 125 by near field communication. Near field communication is a short range wireless communication technology, such as SONY CORP.'s FeliCa technology. Other forms of wireless communication may be employed by the present invention and as described herein. In one embodiment, the remote commander downloads electronic program guide (EPG) data from internet protocol television 125. The downloaded data is then displayed on a display of remote commander 130, such as a liquid crystal display, a surface-conduction electron-emitter display, an interferometric modulator display, etc.

In response to a user's selection of a program displayed on remote commander 130, data indicating selection of the program is transmitted to IPTV 125. In one embodiment, the data is transmitted via infra red (IR) transmission to the television. Because IPTV programs are provided for via URLs, and URLs are usually too large to transmit via IR technology, one embodiment of the present invention utilizes unique identification numbers for programs. The use, creation of, and organization of the identification data is described in greater detail below.

In one embodiment, IPTV 125 maintains two data tables. A first data table includes at least unique program identification data, such as unique and/or randomly generated identification numbers, and URLs for corresponding IPTV programs. The second table includes the unique program identification data and program titles. The second table may further include, in addition to program titles, program reviews, program ratings, program descriptions, related websites, etc. IPTV 125 communicates the second table to remote commander 130, so that remote commander 130 can display a feature full programming guide to a user.

In one embodiment, upon IPTV 125 receiving a selected program transmitted as program identification data from remote commander 130, IPTV 125 requests with the corresponding program URL from the first table. IPTV 125 communicates the request via network 102 (e.g., the Internet, a local network, a Wireless Fidelity (Wi-Fi) network, a Wireless Application Protocol (WAP) Network, a combination of networks, etc.) to content server 140. Content server then supplies the requested programming content from content database 145 to IPTV 125. Content server may be directly coupled with one or more content databases, or may communicate with content databases through network 102. Furthermore, IPTV 125 may request IPTV programming content from multiple content servers (not shown).

IPTV 125 receives the requested content from content server 140 and decodes the content for display on TV 120.

In one embodiment, remote commander 130 reads NFC card 150 to obtain programming content. For example, NFC card 150 may be a promotional card, given to a user free of charge, that stores the ID number of a movie preview site, movie previews, movie trailers, discount offers, prepaid movies, debit movie rental and/or purchase, etc. That is, Sony Pictures may supply a user with a promotional card to a Sony Pictures preview website. After downloading IDs from NFC card 150, remote commander 130 is then able to request programming content, or EPG content, from the Sony Pictures IPTV servers. In one embodiment, when remote commander 130 reads an ID number from NFC card 150, remote commander automatically transmits the ID to IPTV 125. IPTV 125 then communicate the ID to content server 140 in order to obtain EPG data, promotional content, etc. for the NFC card. In one embodiment, instead of remote commander 130 reading NFC card 150, IPTV 125 reads NFC card 150 to obtain corresponding EPG data, promotional content, etc.

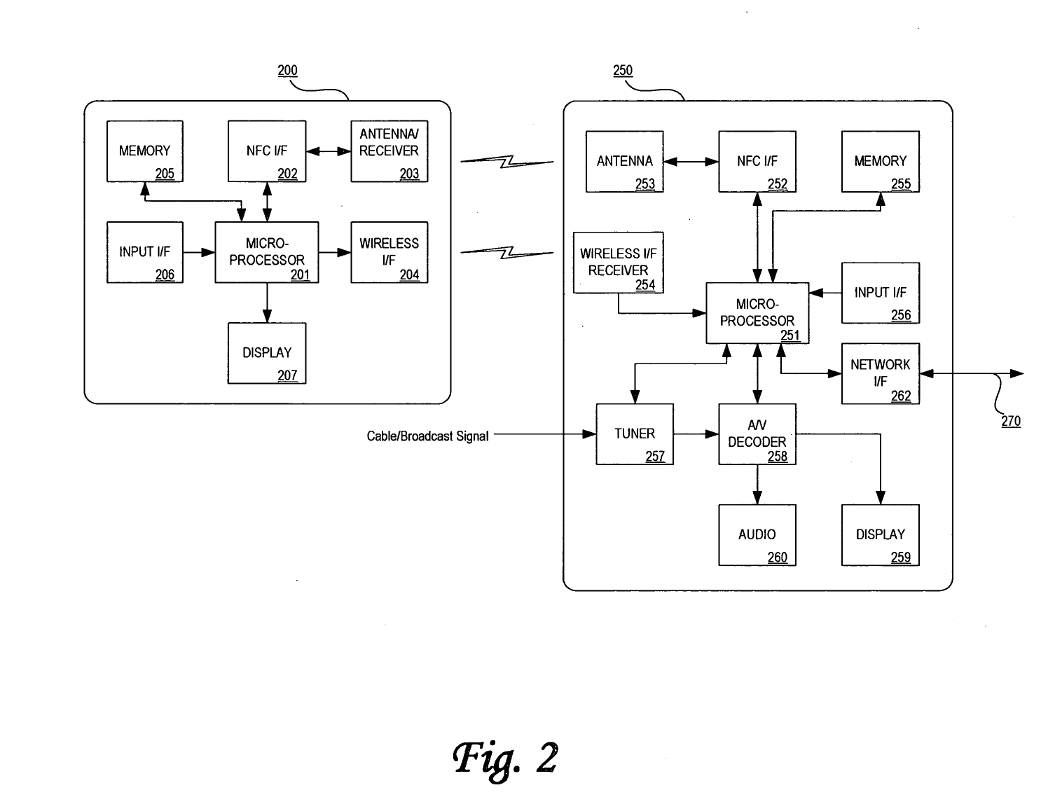

FIG. 2 illustrates one embodiment of an architecture of a remote commander 200 and an internet protocol television 250. Remote command 200 includes a microprocessor 201 that receives user input from input interface 206. User interface may be a key pad, touch pad, touch screen, etc. Microprocessor 201 sends the user input to wireless interface 204 for transmission to IPTV 250. The wireless interface 204 may transmit commands, such as program identification numbers corresponding to a program selected by a user of remote commander 200 to IPTV 250 as IR Light Emitting Diode signals. Other technologies, such as Wi-Fi, may be utilized to communicate commands to an IPTV.

In one embodiment, microprocessor 201 of the remote commander 200 communicates with IPTV 250 using NFC interface 202 and antenna/receiver 203. Data received from an NFC card (not shown) or IPTV 250 displayed to a user via display 207 by microprocessor 201. In one embodiment display 207 is a liquid crystal display (LCD), however any display may be included in remote commander 200. Remote commander further includes a memory 205 to store electronic programming guide data, as described further below.

In one embodiment (MOVE THIS PASSAGE TO FIG. 2), data compression technology (ex. Zone Information Protocol (ZIP), LHA compression, etc.) may be used to improve NFC transmission efficiency by a remote commander. Microprocessor 201 may compress data prior to transmission to IPTV 250. When data is compressed prior to transmission, the data may be reduced from its original size. After microprocessor 251 of IPTV 250 receives the compressed data, the data is reconstituted to the original data. Furthermore, in one embodiment, microprocessor 251 of IPTV 250 may also compress data prior to transmission to remote commander 200. Compression, therefore, allows remote commander 200 and IPTV 250 to communicate/exchange a greater volume of data without consuming more transmission bandwidth.

In one embodiment, if there is sufficient transmission bandwidth, IPTV 250 may send more data other than ID numbers and titles. Further information (e.g., program cast, featured items, related websites, etc.) is sent together with the title. In another embodiment, further information is transmitted via a classified data transmission scheme, as discussed below.

In one embodiment, an e-payment system may be utilized. For example, Sony Corp.'s e-payment system Edy, utilizes FeliCa NFC cards. When remote commander 200 reads a prepayment card, and a charge to the card is withdrawn successfully by a prepayment system (not shown), the remote commander is provided with a password. The password may then be transmitted to an IPTV which allows the IPTV to download pay-per-view programs.

IPTV 250 includes a tuner 257 for receiving cable or broadcast television signals, which are decoded by audio-visual (A/V) decoder 258 and presented to a user via audio output 260 and display 259. Once a television signal is decoded into audio and visual channels by A/V decoder 258, the audio channel is amplified and sent to speakers (e.g., audio unit 260), and the video channel is sent to display 269 (e.g., an LCD, Plasma, Cathode Ray Tube, etc. display). Microprocessor 250 controls both tuner 257 and A/V decoder 258.

In one embodiment, antenna/receiver 254 receives IR commands from remote commander 200. The received commands are then forwarded to microprocessor 251 so that they may be appropriately processed by IPTV 250. Such commands may include channel up/down, volume up/down, key inputs, EPG requests, etc. Furthermore, IPTV 250 communicates with remote commander 200 via NFC interface 252 and/or antenna 253.

IPTV further includes a network interface 262, such as an Ethernet interface, broadband modem interface, digital signal line interface, cable modem interface, etc.

In one embodiment, for IPTV services, microprocessor 251 obtains program information (titles, URLs, icons, etc.) over a network from an IPTV service provider's server, such as content server 140 discussed above in FIG. 1. The received electronic programming guide information is stored in memory 255 and displayed on display 259. A user may scroll through, or navigate, program content on IPTV 250. Furthermore, when a user request for content is received from remote commander 200, microprocessor 251 of IPTV 250 accesses the corresponding URL and downloads the selected program.

As discussed above, IPTV 250 maintains at least two data tables in memory 255. When microprocessor 251 obtains program information from IPTV content servers, microprocessor 251 generates the tow data tables. In one embodiment, a unique identification number is assigned to each IPTV program title, such as a unique 4-digit alpha-numeric code, and a first table includes at least the unique ID and corresponding URL for the programming content. Additional information that describes the content, such as title, icons related the programming content, etc. may also be maintained by IPTV 250 in the first table. An exemplary table is provided below in Table 1:

TABLE 1

| ID # | Title | URL | Icon |
|---|---|---|---|
| 1001 | “Casino | www.sonypictures.com/aaa/bbb | CasinoRoyal.jpg |
| | Royale” | | |
| 1002 | “Spiderman” | www.sonypictures.com/ccc/ddd | Spiderman.jpg |
| 1003 | “Friends- | www.pqrstu.com/xyz | Friends.jpg |
| | Season 1” | | |

In one embodiment, microprocessor 251 utilizes the first table, illustrated above, to generate a second table, which includes at least the unique program IDs and corresponding program titles. An exemplary second table is provided below in Table 2:

TABLE 2

| ID # | Title |
|---|---|
| 1001 | “Casino Royale” |
| 1002 | “Spiderman” |
| 1003 | “Friends-Season 1” |

In one embodiment, when remote commander 200 initiates near field communication, such as by being placed near or “touching” IPTV 250, IPTV 250 transmits the second table from antenna 253 to antenna/receiver 203 of the remote commander 200. Microprocessor 201 of remote commander 200 receives the second table data and stores the table in memory 205. As will be discussed in further detail below, the table, and accompanying information may be transmitted based on a classification scheme, progressively transmitted with additional EPG data.

Microprocessor 201 utilizes the second data table and displays a list of available program titles, and optionally program ID numbers, on display 207 to a user. A user may then select a program at the remote commander by selecting the title of the program, as opposed to a URL, by selecting for example “Casino Royal” on the remote commander via input interface 206. Microprocessor 201 receives the selected title and transmits the corresponding ID number, in this example “1001”, to IPTV 250. Therefore, a user may select new programs while continuing to watch a current program, without disrupting the display of the current program.

In one embodiment, upon IPTV 250 receiving the ID number, IPTV uses the ID number to obtain the URL (i.e., “www.sonypictures.com/aaa/bbb”) in the corresponding data table entry from the first data table stored in memory 255. IPTV then utilizes the URL to download the program stream from a content server. A/V decoder 258 decodes the stream and presents the program to a user via display 258 and audio unit 260.

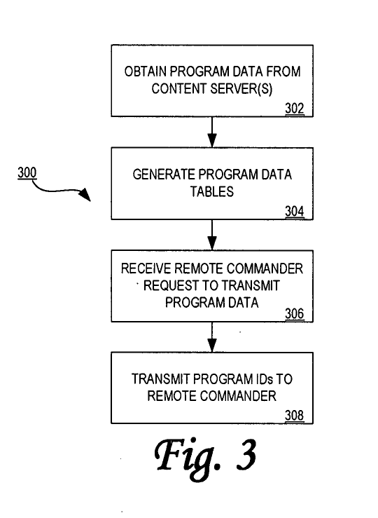

FIG. 3 is a flow diagram of one embodiment of an internet protocol television obtaining programming data. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in a IPTV 250 of FIG. 2.

Referring to FIG. 3, process 300 begins with processing logic obtaining program data from one or more IPTV content servers (processing block 302), such as content server 140 of FIG. 1. In one embodiment, program data includes electronic programming guide data, such as program titles available from a content server, icons corresponding to programs, reviews of the programs, previews of the programs, bonus materials (e.g., commentary, deleted scenes, and alternate endings), etc. Furthermore, in one embodiment, processing logic may be configured to periodically obtain program content from content servers on a regular bases, such as every hour, day, week, etc., so that processing logic may transmit up-to-date EPG data to a remote commander.

Upon obtaining the program data, processing logic generates two data tables (processing block 304). In one embodiment, the first table includes at least unique program identification numbers and a corresponding URLs. Additional data may also be used to populate the first table such as corresponding icons, reviews, titles, etc. In one embodiment, the second data table includes program the unique identification numbers from the first table and corresponding program titles.

When processing logic receives a request from a remote commander to transmit program data (processing block 306), processing logic transmits the second data table to a remote commander 308. In one embodiment, a request may be received when a near field communication capability of processing logic is activated by a remote commander. Instead of NFC, unidirectional IR communications technologies, bidirectional communication technologies, such as ZigBee, Bluetooth, infrared data association (IrDA), etc. may be applied consistently with the discussion herein.

In one embodiment, and as is discussed in greater detail below, favorite titles may be sent first to a remote commander. Such favorite titles would be categorized as such and positioned for transmission prior to non-favorite titles. Because users may only be interested in 10-20% of available titles from content servers, all titles do not have to be sent to a remote commander. In one embodiment, a user sets favorite titles and/or key words (e.g., golf, jazz, cooking, etc.) at an IPTV. Alternatively an IPTV may be configured to analyze and prioritize favorite titles or key words based on a user's prior selections. Furthermore, priorities may be defined via a web interface at a content server.

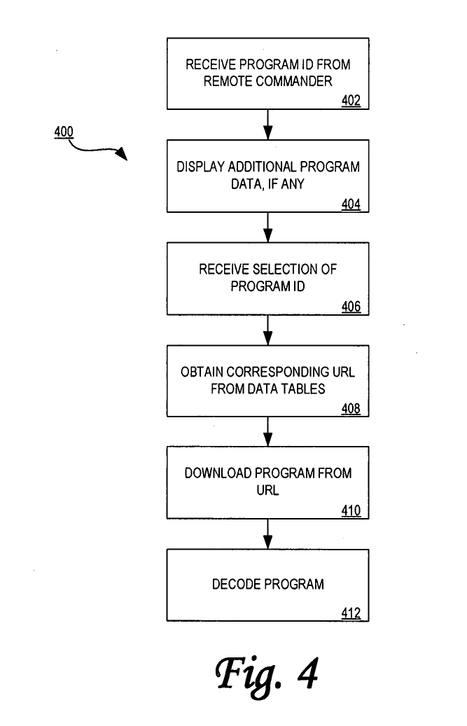

FIG. 4 is a flow diagram of one embodiment of an internet protocol television obtaining content selected by a user. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in IPTV 250 of FIG. 2.

Referring to FIG. 4, process 400 begins with processing logic receiving a program identification number, corresponding to a program, from a remote commander (processing logic 402). It is assumed that either the remote commander has previously received program IDs, as described above in FIG. 3, or has received program IDs from reading an NFC Card, as described above in FIGS. 1 and 2.

Based on the program identification number received from the remote commander, processing logic displays additional program data to a user, if any (processing logic 404). In one embodiment, when processing logic receives an ID number, processing logic may obtain program reviews, icons, pictures, etc. for the IPTV program indicated by the ID number. Processing logic may obtain the additional program data from a data table stored in memory.

In response to processing logic receiving selection of an ID number from a remote commander (processing block 406), processing logic retrieves the URL corresponding to the ID number from a data table stored in memory (processing block 408). Processing logic utilizes the retrieved URL to download the selected IPTV program corresponding to the URL (processing block 410) from a content server. The program is then decoded and displayed by processing logic (processing block 412).

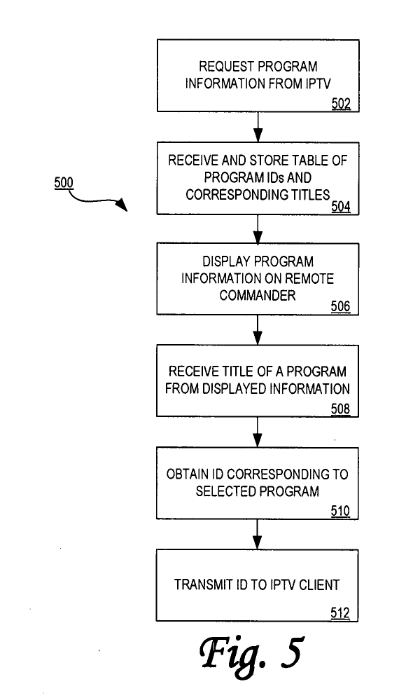

FIG. 5 is a flow diagram of one embodiment of a remote commander utilizing programming data. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in remote commander 200 of FIG. 2.

Referring to FIG. 5, process 500 begins with processing logic requesting program information from an IPTV (processing logic 502). In one embodiment, processing logic requests program information by initiating near field communication with an IPTV. Processing logic then receives and stores a table of program IDs and corresponding program titles (processing block 504).

After processing logic has received program identification numbers and program titles, processing logic may display the program information on a remote commander (processing block 506). In response to processing logic receiving user selection of a program tile from one of the displayed programs (processing block 508), based on the selected title, a corresponding ID number is retrieved by processing logic and transmitted to an IPTV (processing block 512). In one embodiment, programs are selected by a user based on program titles instead of by URLs, and without requiring the user to navigate away from a current IPTV program. Furthermore, the program titles are selected from a display on a remote commander, instead of from navigating URLs on a display of an IPTV.

In one embodiment, available IPTV program content is classified and presented as electronic programming guide (EPG) data on a remote commander. That is, a remote commander may be supplied with data that is organized in an intuitive and familiar programming guide format, such as programs organized by title, availability time, date, etc. In order to address the limited bandwidth and timing constraints for transmitting EPG data, an EPG classification and transmission scheme is presented below.

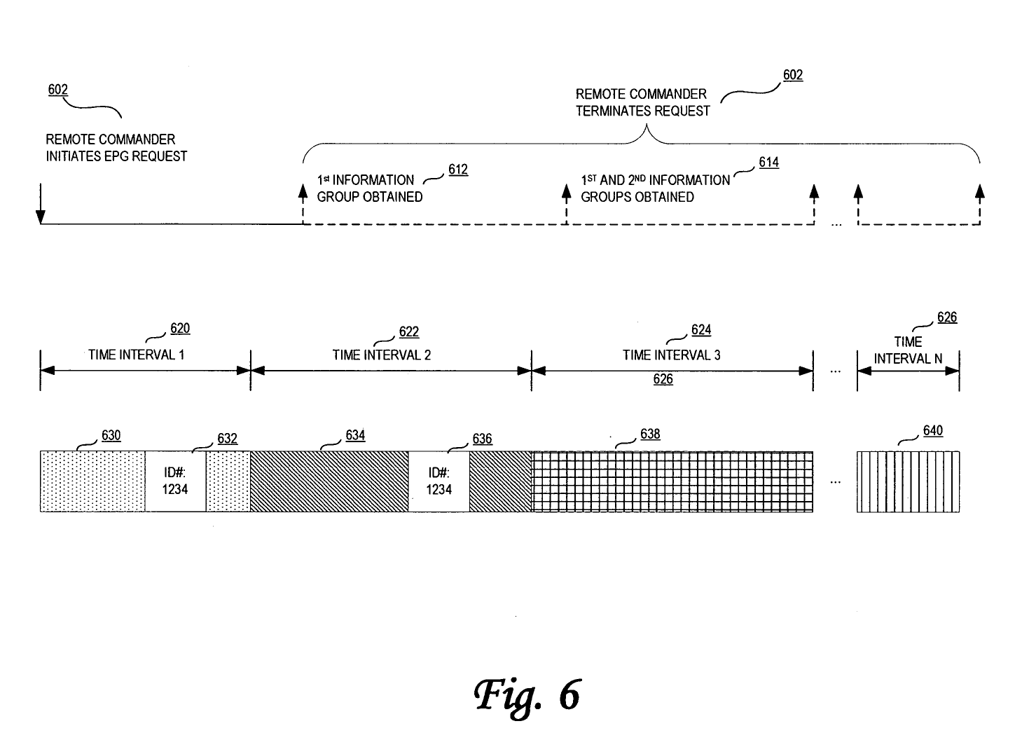

FIG. 6 illustrates one embodiment of a program guide data transfer stream. In one embodiment, program guide data, available from IPTV content servers is classified into three groups. However, as illustrated in FIG. 6, any number of time intervals and data groups may be utilized in an EPG data stream. In one embodiment, a first group of EPG data includes important and/or essential information for programs that will air sometime within the immediate future. For example, a first group of EPG data may include programming guide data for programs that will air in the next two hours. As discussed above, a unique identification number is provided with each available program. Furthermore, because the program's air data/time is imminent, important information such as, for example, title, channel number, date, time, schedule, rating, etc. are included in the first EPG data group to ensure that a user is provided with at least a minimum of EPG information. An example of the first group of program data is presented below in Table 3:

TABLE 3

| | ID #: |
|---|---|
| | 1234 |
| Title: | Casino Royale |
| Channel No.: | 35 |
| Date: | Sep. 27, 2007 |
| Start Time: | 7 PM |
| End Time: | 9 PM |
| Rating: | PG-13 |

In one embodiment, a second group of information may include additional details about each program. For example, data included in the second grouping of EPG data for each program is provided below in Table 4:

TABLE 4

| | ID #: |
|---|---|
| | 1234 |
| Genre: | Action/Suspense |
| Year: | 2006 |
| Cast: | Daniel Craig, Eva Green |
| Director: | Martin Campbell |
| Home Page | <Homepage URL> |
| Theme Song: | <URL of download or purchase |
| | web site> |
| Feature Items: | <URL of information web site> |

As illustrated in Table 3 above, more detailed information for a program title is included in Group 2. The home page information is provided as a URL. When user selection of a home page URL is received, such as by IPTV 250 of FIG. 2, the IPTV opens the “007 Casino Royal” web site. Similarly, by receiving user selection of a theme song for a particular program, a purchase website may be opened by IPTV. Furthermore, when an e-payment card is employed in the IPTV system described above, the e-payment account may be immediately debited and the song downloaded to the IPTV. Furthermore, additional promotion channels, such as a movie studio's promotional channel, may be accessed from an EPG entry.

In one embodiment, a third grouping of EPG data includes EPG data for programs that will not air in the near future. For example, EPG data for programs that will air in the next 6 hours may be included in Group 3. For example, in the case of channel 35 presented in Table 3, the following information may be included in the third grouping of EPG data, as illustrated in Table 5:

TABLE 5

| | ID #: |
|---|---|
| | 1234 |
| Title: | Capote |
| Channel No.: | 35 |
| Date: | Sep. 27, 2007 |
| Start Time: | 9 PM |
| End Time: | 11 PM |
| Rating: | PG-13 |
| | ID #: |
| | 5678 |
| Title: | Pursuit of Happiness |
| Channel No.: | 35 |
| Date: | Sep. 27, 2007 |
| Start Time: | 11 PM |
| End Time: | 1 AM |
| Rating: | PG-13 |

In one embodiment, and as illustrated in FIG. 6, when a remote commander initiates a request for EPG data, an IPTV transmits the first group of data to the remote commander, then the second group, third group, etc. However, the EPG data available for display on a remote commander is dependent on when the request for EPG data is terminated. As illustrated in FIG. 6, an IPTV may be configured to transmit groups of data 630, 634, and 638, according to corresponding time intervals 620, 622, and 624, and based on when a request for EPG data is terminated 610.

For example, upon a remote commander initiating a request for EPG data 602, data corresponding to the first group 632 is transmitted within the first time interval. Then, the longer the request is maintained, the more EPG programming data is received by a remote commander. Furthermore, as illustrated in FIG. 6, any number of time intervals and EPG data groups may be utilized as described herein.

As discussed in more detail below, because each EPG data entry includes a unique program ID, if a remote commander receives data separate from an initial request, the additional data may easily be associated with, and integrated into, existing EPG data. Further, in one embodiment, a service provider classifies EPG data prior to supplying the EPG data to an IPTV. However, an IPTV may receive unclassified EPG data, and classify the data prior to transmission to a remote commander

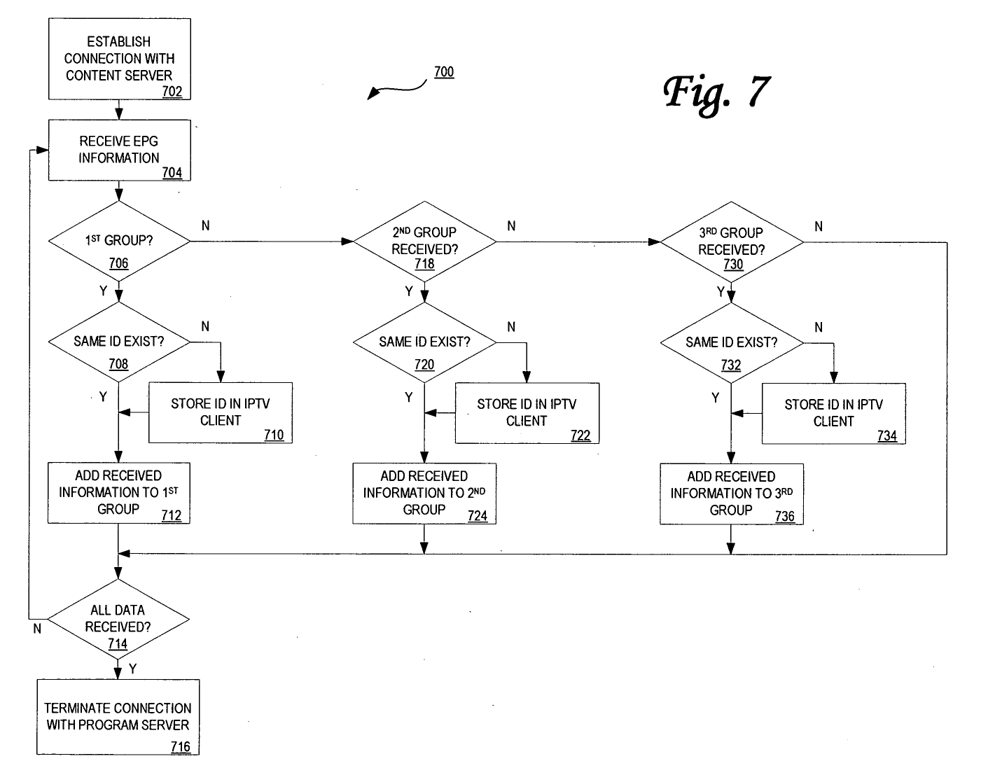

FIG. 7 is a flow diagram of one embodiment for classifying electronic program guide data at an IPTV. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in IPTV 250 of FIG. 2.

Referring to FIG. 7, process 700 begins with processing logic establishing a connection with an IPTV content server (processing block 702), and receiving EPG information (processing block 704). In one embodiment, processing logic requests program information periodically, such as at regular time intervals, or upon receiving a request from a user.

Processing logic determines whether the data being received is from the first group of data (processing block 706), such as by determining if the incoming data includes title, channel number, date, etc. data. If the data being received is from the first group, processing logic then determines if data already exists with the same ID number (processing block 708). If no ID exists, a unique ID is generated by processing logic for the data being received (processing block 710). Then the EPG data is either stored in with information for the first group corresponding to the ID number (processing block 712). If all data has been received (processing block 714), the process ends at processing block 716 and processing logic's connection with the content server is connected. However, if more data is available, the process returns to processing block 704 to receive more EPG data (processing block 714).

In one embodiment, if processing logic determines that the data being received is not from the first group (processing block 706), processing logic then determines if the data is from the second group (processing block 718). Processing logic determines if an ID exists for the second group data (processing block 720). If the ID does not exist, processing logic generates the ID (processing block 722) before storing the received EPG data for the second group (processing block 724).

Similarly, if at processing block 718, processing logic determines that the data being received is not from the second group, processing logic then determines if the data is from the third group (processing block 730). Processing logic determines if an ID exists for the third group data (processing block 732). If the ID does not exist, processing logic generates the ID (processing block 734) before storing the received EPG data for the second group (processing block 736). However, if the data being receive is not from the third group data, processing logic ignores the data and determines if all data has been received (processing block 714).

Therefore, in one embodiment, EPG data received by processing logic, such as by processing logic of an IPTV, is classified into the appropriate groups for prioritized transmission to a remote commander.

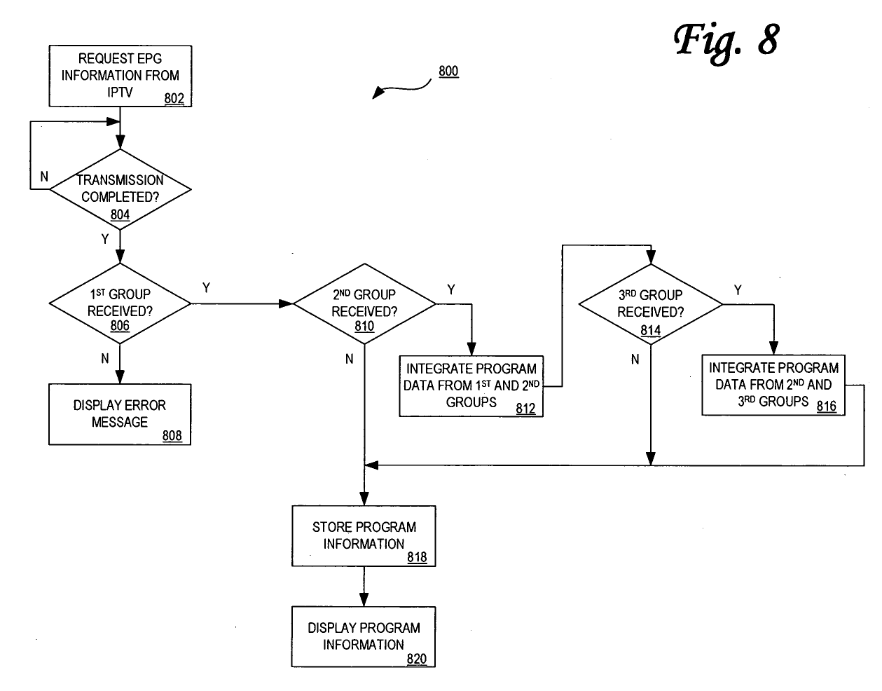

FIG. 8 is a flow diagram of one embodiment for receiving classified electronic programming data at a remote commander. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in a remote commander 200 of FIG. 2.

Referring to FIG. 8, process 800 begins with processing logic requesting EPG information from an IPTV (processing block 802). As discussed above, a request for EPG data may be initiated by activating near field communication between a remote commander and an IPTV. However, the request may also be received manually from a user.

Processing logic determines if the transmission has been completed (processing block 804), and waits until the request is terminated. That is, processing logic receives and stores all data prior to integrating any EPG data with EPG data already stored by remote commander. Once the EPG data transmission has been completed, processing logic determines if the first group has been received (processing block 806). If the first group has not been received an error message, such as an LED display, an error message display on a remote commanders LCD, etc. is triggered by processing logic (processing block 808) to alert the user that the request for EPG data was unsuccessful. In one embodiment, the first group may not be received because a NFC link between a remote commander and an IPTV was not maintained for a sufficient duration of time.

In one embodiment, if the first group has been received, processing logic then determines if the second group of information has also been received (processing block 812). If the second group has not been received the EPG data corresponding to the first group is stored (processing block 818) and displayed on the remote commander (processing block 820).

If the first and second group of EPG data is received, however, processing logic integrates the EPG data from the first and second groups (processing block 812), based on unique program ID numbers. In one embodiment, because each program is provided with a unique ID, processing logic utilizes the unique ID to integrate EPG data from different data groups.

After EPG data from the first and second group is integrated, processing logic determines if the third group of EPG data has been received (processing block 814). If the third group has not been received, the integrated first and second EPG data groups are stored (processing block 818) and subsequently displayed on the remote commander (processing block 820). However, if data from the first, second, and third group has been received, all of the EPG data is integrated (processing block 816) before it is stored (processing block 818) for subsequent display by processing logic (processing block 820).

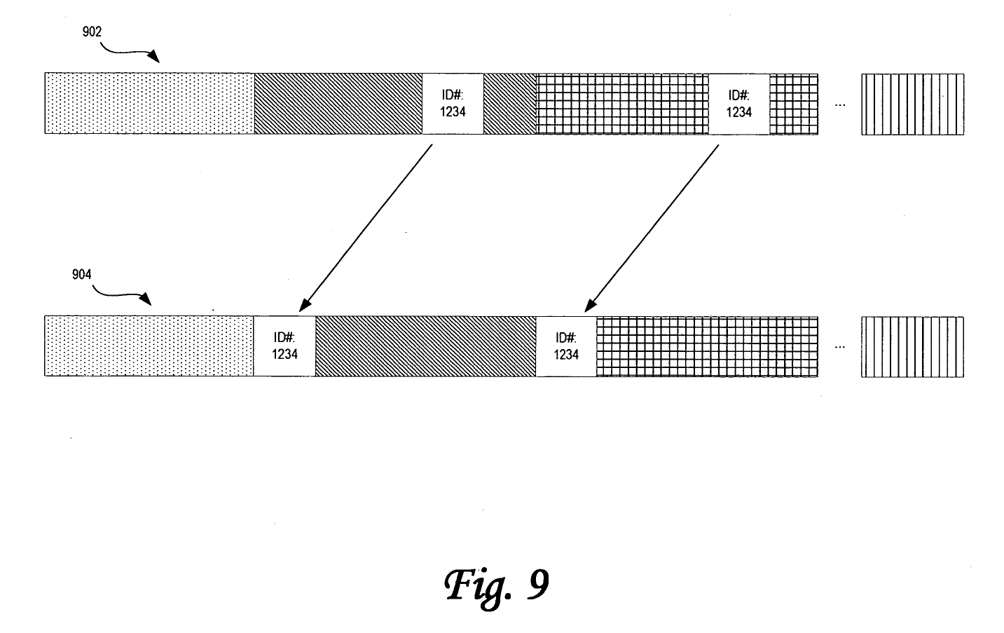

FIG. 9 illustrates one embodiment of a prioritized program content data stream. In one embodiment, prior to transmission of EPG data from an IPTV to a remote commander, the IPTV prioritizes one or more pieces of EPG data, as discussed in greater detail above. For example the IPTV may prioritize favorite programs, prioritize programs based on a history of requested programs, etc.

In one embodiment, an IPTV such as IPTV 250 of FIG. 2, stores channel numbers or programs that are often selected. IPTV may further determine favorites based on similarly selected program genres (e.g., cooking shows, sporting events, suspense movies, etc.), actor/actress, time band within which programs are frequently watched, etc. Additionally, an IPTV may receive a user's manual selections of favorites that either specify particular favorites, or specify keywords, categories, genres, etc. For example, a user may enter “007” indicating that he or she likes James Bond or “007” movies.

Based on determined or received preference information, an IPTV searches EPG data for programs that satisfy favorite constraints. When such information is found 902, the EPG information is arranged at the beginning of the second and/or third groups 902 during the classification described above in FIG. 7. Therefore, when a remote commander receives EPG information, as described above in FIG. 8, the remote commander receives favorite information even during short EPG data requests. Furthermore, program favorites may be stored along with a favorites flag at a remote commander. Thus, when a remote commander encounters a “favorite,” that program can be displayed prior to other programs, the program may be highlighted, or otherwise visually distinguished.

For example, assume that EPG data transmission is transmitted during the second group of information in FIG. 9. Furthermore, assume that an IPTV has determined, either through analyzing viewing patterns or by receipt of a manual selection, that a user's favorite is “007” programs. Prior to transmitting an EPG data stream to a remote commander, the IPTV could determine that a favorite (e.g., program “Casino Royal” identified by ID number #1234) is coming up. The EPG data could then be arranged to place the EPG data for the program at the beginning of the second and/or third data groups. Thus, the result of a short request for programming information would provide the remote commander with increased programming information for determined favorites.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method, comprising:
receiving electronic programming guide (EPG), that includes a plurality of unique identification numbers and corresponding program titles, data at a remote commander;
storing the EPG data in a memory of the remote commander;
displaying the plurality of program titles on a display of the remote commander; and
in response to receiving a selection of a title at the remote commander, transmitting the unique identification number corresponding to the selected title to an internet protocol television (IPTV).

2. The method of claim 1, wherein the receiving further comprises:
activating a communications link with the IPTV;
receiving the EPG data classified into a plurality of groups; and
organizing the received EPG data for each group based on the unique identification numbers.

3. The method of claim 2 further comprises:
integrating the received EPG data, with existing EPG data stored on the remote commander, based on the unique identification numbers.

4. The method of claim 2, wherein the EPG data is classified into a plurality of groups based on a progressive level of information for each program title.

5. The method of claim 2, wherein the EPG data classified into a plurality of groups is arranged for progressive transmission to the remote commander.

6. The method of claim 1, wherein the plurality of program titles are displayed on the display of the remote commander while an IPTV presents a current program on a display of the IPTV.

7. The method of claim 1, further comprising:
requesting, by the IPTV, EPG data from one or more IPTV content servers;
receiving a plurality of URLs for content supplied by the one or more IPTV content servers;
generating at least a first data table and a second data table, wherein the first data table stores a plurality of unique identification numbers and a corresponding universal resource locators (URL) and one or more of a related URLs, program cast information, program rating, program reviews, related purchase websites, and the second data table stores the plurality of unique identification numbers and corresponding program titles.

8. The method of claim 7, further comprises:
receiving the unique identification number corresponding to the selected title at the IPTV;
obtaining a universal resource locator from the second table based on the received unique identification number;
requesting content corresponding to the URL from a content server; and
displaying the content at the IPTV upon receipt of the content at the IPTV.

9. The method of claim 1, wherein the receiving further comprises:
receiving EPG data that has been prioritized by the IPTV based on at least a determined user preference.

10. The method of claim 1, wherein at least one of the program titles is classified as a favorite and is visually distinguished from non-favorite program titles when displayed by the remote commander.

11. The method of claim 1, wherein the received EPG data is received as compressed EPG data.

12. The method of claim 1, wherein the receiving occurs over a near field communications (NFC) link between the remote commander and the IPTV.

13. The method of claim 1, further comprises:
reading EPG data from a Near Field Communications (NFC) card;
storing a plurality of unique identification numbers and program titles for EPG data from the NFC card in the memory of the remote commander;
in response to receiving a selection of a title from the NFC card at the IPTV, transmitting the unique identification number corresponding to the selected title to a content server;
debiting an account corresponding to the NFC card by an e-payment system of the content server; and
supplying the selected title to the IPTV upon successful debiting of the account.

14. An apparatus, comprising:
means for receiving electronic programming guide (EPG), that includes a plurality of unique identification numbers and corresponding program titles, data at a remote commander;
means for storing the EPG data in a memory of the remote commander;
means for displaying the plurality of program titles on a display of the remote commander;
in response to receiving a selection of a title at the remote commander, means for transmitting the unique identification number corresponding to the selected title to an internet protocol television (IPTV).

15. The apparatus of claim 14, further comprises:
means for activating a communications link with the IPTV;
means for receiving the EPG data classified into a plurality of groups; and
means for organizing the received EPG data for each group based on the unique identification numbers; and
means for integrating the received EPG data, with existing EPG data stored on the remote commander, based on the unique identification numbers.

16. The apparatus of claim 14 further comprises:
means for requesting, by the IPTV, EPG data from one or more IPTV content servers;
means for receiving a plurality of URLs for content supplied by the one or more IPTV content servers;
means for generating at least a first data table and a second data table, wherein the first data table stores a plurality of unique identification numbers and a corresponding universal resource locators (URL) and one or more of a related URLs, program cast information, program rating, program reviews, related purchase websites, and the second data table stores the plurality of unique identification numbers and corresponding program titles.

17. A system, comprising:
an Internet Protocol Television (IPTV) to
request electronic programming guide (EPG) data from one or more IPTV content servers;
receive a plurality of URLs for content supplied by the one or more IPTV content servers in response to the request, and
generate at least a first data table and a second data table, wherein the first data table stores a plurality of unique identification numbers and a corresponding universal resource locators (URL), and the second data table stores the plurality of unique identification numbers and corresponding program titles; and
a remote commander in communication with the IPTV to
receive electronic programming guide (EPG) data that includes a plurality of unique identification numbers and corresponding program titles,
store the EPG data in a memory of the remote commander,
display the plurality of program titles on a display of the remote commander, and
transmit the unique identification number corresponding to the selected title to the IPTV in response to receipt of user selection of a title.

18. The system of claim 17, wherein the remote commander is further to activate a communications link with the IPTV, receive the EPG data, classified into a plurality of groups, and organize the received EPG data for each group based on the unique identification numbers.

19. The system of claim 17, wherein the remote commander is further to receive EPG data that has been prioritized by the IPTV based on at least a determined user preference.

20. The system of claim 17, wherein the remote commander is further to integrate the received EPG data, with existing EPG data stored on the remote commander, based on the unique identification numbers.
